(19) United States
(12) Patent Application Publication
(10) Pub. No.: US 2022/0203819 A1
(43) Pub. Date: Jun. 30, 2022

(54) Hybrid Transmission Device and Motor Vehicle

(71) Applicant: ZF Friedrichshafen AG, Friedrichshafen (JP)

(72) Inventors: Stefan Beck, Eriskirch (DE); Matthias Horn, Tettnang (DE); Fabian Kutter, Kressbronn (DE); Johannes Kaltenbach, Friedrichshafen (DE); Michael Wechs, Weißensberg (DE); Thomas Martin, Weissensberg (DE); Thomas Kroh, Lindau (DE); Oliver Bayer, Hörbranz (AT); Martin Brehmer, Tettnang (DE); Peter Ziemer, Tettnang (DE); Max Bachmann, Friedrichshafen (DE)

(21) Appl. No.: 17/438,189

(22) PCT Filed: Oct. 15, 2019
(86) PCT No.: PCT/EP2019/077880

§ 371 Date: Sep. 10, 2021

(30) Foreign Application Priority Data
Mar. 14, 2019 (DE) 10 2019 203 486.1

(51) Int. Cl. B60K 6/40; B60K 6/36; B60K 6/547; F16H 3/091; B60K 6/387; B60K 6/442

(52) U.S. Cl. CPC B60K 6/40; B60K 6/36; B60K 6/547; B60Y 2200/92; B60K 6/387; B60K 6/442; F16H 2200/0052; F16H 3/091

(57) ABSTRACT

A hybrid transmission device (3) includes at least one drive device (EM2) and a transmission (4) with a first transmission input shaft (12) and a second transmission input shaft (14) mounted on the first transmission input shaft (12). A differential (32) is arranged in an axial direction at an engine-side end (21) of the first transmission input shaft (12).

The invention relates generally to a hybrid transmission device with at least one drive device, a transmission including a first transmission input shaft and a second transmission input shaft mounted on the first transmission input shaft.

### CROSS-REFERENCE TO RELATED APPLICATIONS

The present application is related and has right of priority to German Patent Application No. 102019203486.1 filed in the German Patent Office on Mar. 14, 2019 and is a nationalization of PCT/EP2019/077880 filed in the European Patent Office on Oct. 15, 2019, both of which are incorporated by reference in their entirety for all purposes.

### FIELD OF THE INVENTION

It is known to utilize hybrid transmission devices to reduce carbon dioxide (CO2) emissions of motor vehicles. A hybrid transmission device is understood to be a transmission device, onto which an internal combustion engine and at least one further drive device are couplable. It is known to hybridize all automated transmissions, for example, automatic transmissions and dual clutch transmissions. DE10 2011 005 451 A1 describes a transmission, which includes two electric motors and has five forward gears and one reverse gear.

### SUMMARY OF THE INVENTION

Example aspects of the present invention provide a hybrid transmission device, which has a compact design for front-transverse applications.

The hybrid transmission device includes a differential arrangement, which is arranged in the axial direction at the engine-side end of the first transmission input shaft. As a result, an installation space-efficient arrangement can be achieved.

The transmission of the hybrid transmission device is advantageously designed as a gear change transmission. The transmission has at least two discrete gear steps in this case.

Advantageously, the gear change transmission can include at least two, in particular precisely two, sub-transmissions. This allows for increased functionality and, for example, tractive force support during a gear change, in particular an internal-combustion-engine gear change as well as an electric gear change.

Preferably, at least one of the sub-transmissions can be designed as a gear change transmission. In particular, precisely one sub-transmission can be designed as a gear change transmission. One sub-transmission then has at least two gear steps and the other or the others have precisely one gear step.

Advantageously, one sub-transmission can have precisely two gear steps. In addition, a second sub-transmission can have precisely one gear step.

Advantageously, the gear change transmission includes gearwheels and shift elements. The gearwheels are preferably designed as spur gears.

Preferably, the transmission of the hybrid transmission device is designed as a stationary transmission. In stationary transmissions, the axles of all gearwheels in the transmission are fixed in relation to the transmission housing.

Preferably, the gear change transmission is designed as a transmission of a countershaft design. Preferably, the gear change transmission is designed as a spur gear drive. The gearwheels are designed as spur gears in this case.

In addition, the transmission can be designed as a dual clutch transmission. The transmission has two transmission input shafts in this case.

Preferably, the transmission can include at least two shafts. These are necessary for forming the gear steps when the transmission is designed as a stationary transmission.

In addition, the transmission preferably includes at least one, in particular at least two, transmission input shafts. Preferably, the transmission includes precisely two transmission input shafts. With three or more transmission input shafts, although a larger number of sub-transmissions can be produced, it has been proven that the described functionality can be achieved already with two transmission input shafts.

Preferably, the first transmission input shaft is designed as a solid shaft. Regardless of the design of the first transmission input shaft, the second input shaft is preferably mounted on the first transmission input shaft, i.e., the second input shaft is arranged coaxially thereto and encloses the first input shaft. The second input shaft is a hollow shaft in this case.

Preferably, the hybrid transmission device can include at least one, in particular precisely one, countershaft. In the case that a single countershaft is utilized, a single point of connection to the differential is present. As a result, installation space can be saved, which is the case in the radial direction as well as in the axial direction.

Therefore, the transmission in one preferred example embodiment includes precisely three shafts, namely two transmission input shafts and one countershaft, which is also the output shaft in this case.

In an all-wheel variant of the transmission, one shaft is always added, which, as a power take-off, drives the second motor vehicle axle.

A gear step, as already described at the outset, is a mechanically implemented ratio between two shafts. The overall gear ratio between the internal combustion engine or the drive device and the wheel has further ratios, wherein the ratios upstream from a gear step, the pre-ratios, can depend on the input that is utilized. The post-ratios are usually identical. In an example embodiment shown further below, the rotational speed and the torque of a drive device are transmitted multiple times, namely by at least one gearwheel pair between the output shaft of the drive device and a transmission input shaft. This is a pre-ratio. This is followed by a gearwheel pair of a gear step with a ratio dependent on the gear step. Finally, this is followed by a gearwheel pair between the countershaft and the differential, as a post-ratio. A gear has an overall gear ratio that depends on the input and the gear step. Unless indicated otherwise, a gear relates to the utilized gear step.

Merely for the sake of clarity, it is pointed out that the ascending numbers of the gear steps refer, as usual, to a descending ratio. A first gear step G1 has a higher ratio than a second gear step G2, etc. The numbers do not indicate a specific ratio, however. The ratio of the first gear step G1 can correspond, for example, to that of a fourth gear step in a transmission having six gear steps.

If torque is transmitted from the internal combustion engine via the first gear step G1, this is referred to as an internal-combustion-engine gear V1. If the second drive device and the internal combustion engine simultaneously transmit torque via the first gear step G1, this is referred to as a hybrid gear H11. If only the second drive device transmits torque via the first gear step G1, this is referred to as an electric gear E1.

Preferably, the transmission of the hybrid transmission device has at least three gear steps or gear stages. The gearwheels of a gear step can be arranged in a gear plane when the gear step includes two gear-step gears. Advantageously, the transmission has precisely three gear steps.

Preferably, the transmission of the hybrid transmission device has one gear plane more than forward gear steps. In the case of three gear steps, this is four gear planes. The gear plane for connecting the drive output, for example, a differential, is included in the count.

In a first alternative example embodiment, all gear steps can be utilized in an internal combustion engine-driven and electric or fluidic manner. As a result, a maximum number of gears can be obtained given a low number of gear steps. In a second alternative example embodiment, at least one, in particular precisely one, gear step is reserved solely for the internal combustion engine of the hybrid drive train, i.e., an internal-combustion-engine gear step. In this example embodiment, at least one other gear step can be usable for transmitting torque of the internal combustion engine as well as of a drive device. Preferably, all further gear steps are usable for transmitting torque of the internal combustion engine as well as of a drive device.

Advantageously, the hybrid transmission device and/or the transmission can be designed to be free from a reversing gearwheel for reversing the direction. Therefore, the reverse gear is not produced via the internal combustion engine, but rather via the electric motor or at least one of the electric motors. In this case, for example, the first gear step or the second gear step can be utilized.

Preferably, gear-step gearwheels for all even gear steps can be arranged on the first transmission input shaft. In addition, gear-step gears of all odd gear steps can be preferably arranged at the second transmission input shaft. Gear-step gears, which are also referred to as gear-step gearwheels, can be designed as fixed gears or idler gears. Such gears are referred to as gear-step gears, because the gears are associated with a gear step.

Preferably, the highest odd gear step and/or one of the gear-step gears associated therewith are/is located at the axial end of the transmission input shaft that supports one of the gear-step gearwheels of the highest odd gear step. Preferably, the highest odd gear step is the third gear step and/or the transmission input shaft is the second transmission input shaft.

In a first example embodiment, in sum, the gear-step gearwheels of the highest gear step can be located at the axial outer sides of the shafts, in particular of the transmission input shafts. If the transmission has three gear steps, the third gear step, i.e., the gearwheels of the third gear step, are arranged axially outward.

Preferably, the gear-step gears of the third gear step and of the first gear step can be arranged on the second transmission input shaft from the outer side of the hybrid transmission device toward the inner side.

Preferably, the connecting gearwheel of one drive device and a gear-step gear of the second gear step can be arranged on the first transmission input shaft from the outer side of the hybrid transmission device toward the inner side. Alternatively, a gear-step gear of the second gear step can also be exclusively arranged on the first transmission input shaft.

In a first example embodiment, the hybrid transmission device can have precisely one drive device.

Preferably, the hybrid transmission device can include at least two, in particular precisely two, drive devices. An arrangement of one or multiple drive device(s) that act(s) at a certain point of the hybrid transmission device counts as a drive device. This means, for example, in an example embodiment of the drive devices as electric motors, that multiple small electric motors can also be considered to be one electric motor if the multiple small electric motors summarize torque at a single starting point at the transmission.

Advantageously, at least one drive device each can be associated with the first transmission input shaft as well as with the second transmission input shaft. The gears implemented via the first transmission input shaft and the gears implemented via the second transmission input shaft form a sub-transmission in each case. It may therefore also be stated that at least one drive device is associated with each sub-transmission. Preferably, the hybrid transmission device includes at least two, in particular precisely two, sub-transmissions.

Preferably, at least one of the drive devices is designed as a generator.

Preferably, the first drive device and/or the second drive device are/is designed as a motor and as a generator.

Preferably, the drive device is connected to the highest gear step of the transmission. In the case of two drive devices, it is advantageously provided, in a first example embodiment, that the two drive devices are connected to the two highest gear steps. In a further example embodiment, it is provided that one drive device is connected at the highest gear step and the other drive device is connected at a connecting gearwheel. A connecting gearwheel is a gearwheel, which is utilized exclusively for connecting the drive device to a shaft, in particular a transmission input shaft and, therefore, does not belong to a gear step.

Preferably, the drive device is connected to an axially externally situated gear step, more precisely, to one of the gearwheels of the gear step, of the transmission. In the case of two drive devices, it is advantageously provided that both of the two drive devices are connected to an axially externally situated gear step of the transmission. Alternatively, it can be provided that both drive devices are connected to an axially externally situated gearwheel of the transmission. As a result, the center distance of the connection points can be maximized. The axial external position relates in this case to the axis of the shaft or shafts, to which the drive devices are connected, i.e., the transmission input shafts.

At this point, it is to be pointed out that, in the present invention, a connection or operative connection refers to any power flow-related connection, also across other components of the transmission. A connection, however, refers to the first connecting point for transmitting drive torque between the drive device and the transmission.

A connection to a gear step, i.e., one of the gear-step gearwheels of the gear step, can take place via a gearwheel. An additional intermediate gear may be necessary, in order to bridge the center distance between the output shaft of the drive device and the transmission input shaft. Due to the connection of the drive device to a gear-step gearwheel, a further gear plane can be avoided, which would be present only for the connection of the drive device.

Advantageously, at least one of the axially external gear-step gears, which are arranged on the axis of the transmission input shafts, can be designed as a fixed gear. Preferably, both axially external gear-step gears can be designed as fixed gears. In this case, the drive devices are connected to a fixed gear on the first transmission input shaft and/or to a fixed gear on the second transmission input shaft. A connecting gearwheel instead of one of the gear-step gearwheels can also be provided axially externally as described above. This can also be designed as a fixed gear. The drive devices can therefore preferably be arranged in a P3 arrangement, i.e., at the transmission gear set.

Preferably, one drive device can be connected to the third gear stage.

Alternatively or additionally, one drive device can be connected to a connecting gearwheel.

Preferably, the first drive device can be rotationally fixed to the internal combustion engine in all internal-combustion-engine forward gears and/or during an internal-combustion-engine gear change. In this case, a constant connection exists between the internal combustion engine and the first drive device during internal combustion engine-driven travel. Preferably, the first drive device can be utilized, at least intermittently, as a generator in all forward gears.

Preferably, the second drive device can be utilized for an electric or fluidic forward starting operation. In this case, the second drive device can be coupled, advantageously, to the gear-step gears of the first gear. The starting operation is always performed by the second drive device. The second drive device can preferably be utilized as a sole drive source for the starting operation. The second drive device can also be utilized for electric or fluidic travel in reverse. Preferably, it can also be provided here that the second drive device is the sole drive source during travel in reverse. In this case, there are no internal-combustion-engine or hybrid reverse gears.

Preferably, the drive device or the drive devices can be arranged axially parallel to the first transmission input shaft. The drive device(s) is/are then preferably also axially parallel to the second transmission input shaft and to the countershaft. In the present invention, an axially parallel arrangement refers not only to completely parallel arrangements. An inclination or an angle between the longitudinal axis of the transmission input shafts and the longitudinal axis of the electric motor can also be present. Preferably, an angle is provided between the longitudinal axis of an electric motor and the longitudinal axis of the transmission input shafts of less than or equal to ten degrees (10°), further preferably less than five degrees (5°) and, in particular zero degrees (0°). Slight inclinations of the drive devices in comparison to the transmission can result for reasons related to installation space.

Preferably, the drive devices can be counter-rotatingly arranged. This means, the output shafts of the drive devices point toward different, opposite sides. If the first drive device has an output side on the left, the second drive device has an output side on the right or, if the viewing direction is changed, one drive device has an output side at the front and the other drive device has an output side at the rear. As a result, the engagement point of the drive devices at the hybrid transmission device are axially spaced apart and improved coverage in the axial direction is achieved.

Preferably, the axes of the drive devices in the installation position can be situated above the axis of the transmission input shaft. The installation position is always referenced in the following. During installation, the hybrid transmission device can also be upside down. Such positions are irrelevant for the following description, however. While the axially parallel arrangement also makes it possible for one of the drive devices to be located below the axis of the transmission input shaft, it is advantageously provided that the drive devices and, thereby, the axes of the drive devices are positioned above the transmission input shaft. In this arrangement, the packing density can be maximized.

In addition, the axes of the drive devices in the installation position can be situated on both sides of the axis of the transmission input shaft. Therefore, one of the drive devices and/or the axis if the one drive device are/is situated to the left of the axis of the transmission input shaft and the other(s) are/is situated to the right of the axis. Reference is made here to the view of the axes in cross-section.

Preferably, it can be provided that the axes of the drive devices in the installation position are arranged symmetrically with respect to the axis of the transmission input shaft. In particular, the axes of the drive devices are to be symmetrically arranged with respect to distance and angular position, wherein the angle is based on the perpendicular. The drive devices can be counter-rotatingly arranged without ruining the symmetrical arrangement, since the position of the axes is all that matters here.

Preferably, the axes of the drive devices in the installation position can be situated above the axes of one or multiple countershaft(s) and/or one or multiple output shaft(s). The drive devices are therefore situated above the aforementioned components of the spur gear drive arrangement. Alternatively, it can therefore be said that the axes of the drive devices in the installation position are the uppermost axes of the hybrid transmission device.

Preferably, the drive devices can be arranged offset in the circumferential direction. The circumferential direction is established with respect to the longitudinal axis of the transmission input shaft, which, by definition, is considered in the present invention to be the longitudinal axis of the hybrid transmission device.

It is preferred when the drive devices are arranged at least partially overlapping in the axial direction. Preferably, the overlap in the axial direction can be more than seventy-five percent (75%). If the drive devices should be of unequal length, the shorter drive device is used as the basis for calculating the overlap. The overlap is determined with reference to the housing of the drive devices. The output shaft of the drive devices is not taken into account.

The drive devices can be arranged in the axial direction preferably at the same level as the gear change transmission. Preferably, the overlap in the axial direction can be more than seventy-five percent (75%). Advantageously, it is one hundred percent (100%). Here, the overlap is determined with reference to the housing of the drive devices and, in particular, of the housing of the longer drive device. The output shaft of the drive devices is not taken into account.

Preferably, the first drive device and/or the second drive device can be designed as an electric motor. Electric motors are widespread in hybrid transmission devices.

Alternatively or additionally, the first drive device and/or the second drive device can be designed as a fluid power machine. In addition to electric motors, there are other prime movers, the utilization of which in hybrid transmission devices is conceivable. The other prime movers can also be operated as motors, i.e., in a manner that consumes energy, or as generators, i.e., in a manner that converts energy. In the case of a fluid power machine, the energy accumulator is, for example, a pressure reservoir. The energy conversion then involves converting the energy from the internal combustion engine into a pressure build-up.

Advantageously, the first drive device and the second drive device can be power-shifted. A powershift is understood here, as usual, to mean that no interruption of tractive force occurs at the output of the hybrid transmission device during a gear change, for example, of the first drive device. A reduction of the torque present at the output is possible, but a complete interruption is not.

As a result, the motor vehicle can be continuously driven in large speed ranges, for example, exclusively electrically, wherein the ratio, i.e., the gear, is selected in each case so as to be optimized with respect to the rotational speed and torque of the drive device.

Preferably, the second drive device can output torque to the drive output while the first drive device is shifted. In other words, the gear step is changed, via which the first drive device transmits torque to the drive output.

Preferably, the first drive device can output torque to the drive output while the second drive device is shifted. This means, the gear step is changed, via which the second drive device transmits torque to the drive output. It may therefore also be stated that the drive devices are power shiftable with each other. The internal combustion engine therefore does not need to be started for a gear change during electric travel.

Preferably, at least one of the drive devices can be connected to the transmission via a P3 connection. Advantageously, both drive devices are connected to the transmission via this connection. In a P3 connection, the drive devices engage at the transmission between the input shaft and the output shaft.

Advantageously, both drive devices can be operatively connected to a differential via, at most, four meshing points. As a result, good efficiency is achieved.

Advantageously, the first transmission input shaft can be directly connectable or connected to an internal combustion engine. Directly connected refers to a clutch-free connection. A damper unit can be present, for example, between the crankshaft and the first transmission input shaft.

Preferably, a connecting clutch can be provided for connecting the first transmission input shaft and the second transmission input shaft. This is utilized for coupling the sub-transmission. However, it is also a clutch for connecting the second transmission input shaft to the internal combustion engine, wherein the connection extends via the first transmission input shaft.

Preferably, the connecting clutch can be arranged at the end of the second transmission input shaft facing the transmission. This allows for a particularly compact design of the transmission.

Advantageously, the connecting clutch can be designed as part of a two-sided engagement device. The connecting clutch, due to positioning, is integratable into a two-sided engagement device.

In the present invention, an engagement device is understood to be an arrangement with one or two shift element(s). The engagement device is designed to be one-sided or two-sided. A shift element can be a clutch or a gearshift clutch. A clutch is utilized for connecting two shafts in a rotationally fixed manner and a gearshift clutch is utilized for rotationally fixing a shaft to a hub rotatably mounted thereon, for example, an idler gear. The connecting clutch, therefore, is designed as a gearshift clutch and, preferably, also as part of a gearshift clutch and is referred to as a clutch only because the connecting clutch connects two shafts to each other. The clutches for connecting the transmission input shafts to the internal combustion engine connect the particular transmission input shaft to a crankshaft of the internal combustion engine.

Preferably, at least a portion of the clutches and/or gearshift clutches can be designed as dog clutches. In particular, all clutches and gearshift clutches can be designed as dog clutches.

Advantageously, at least one engagement device can be arranged on the first transmission input shaft. Advantageously, precisely one engagement device can be arranged on the first transmission input shaft. This can be advantageously designed as a two-sided engagement device.

The engagement device on the first transmission input shaft preferably includes a gearshift clutch and a clutch.

Advantageously, the second transmission input shaft can be designed to be engagement device-free and/or idler gear-free. Preferably, at least one fixed gear can be arranged on the second transmission input shaft. In particular, at least two, in particular precisely two, fixed gears can be arranged on the second transmission input shaft.

Preferably, at least one, in particular precisely one, idler gear can be arranged on the first transmission input shaft.

Preferably, at least two, in particular precisely two, fixed gears can be arranged on the first transmission input shaft. One of the fixed gears can be arranged as a gear-step gear and the second fixed gear can be arranged as a connecting gearwheel.

Advantageously, one fixed gear and one idler gear can be associated with each gear step and, in fact, a single fixed gear and a single idler gear in each case. In addition, each fixed gear and idler gear can always be unambiguously associated with a single gear step, i.e., there are no winding-path gears by utilizing one gearwheel for multiple gears. Nevertheless, the internal-combustion-engine gears one and three can be considered to be winding-path or coupling gears, as described below, since the first transmission input shaft is interconnected during the formation of the gears.

In one preferred example embodiment, the hybrid transmission device and/or the transmission can include precisely two two-sided engagement devices for producing three internal-combustion-engine gear stages. The connecting clutch advantageously forms a part of one of the two-sided engagement devices.

Preferably, a differential can be arranged in the axial direction at the engine-side end of the first transmission input shaft. Advantageously, a gearwheel for connecting the differential can be arranged axially externally on a countershaft. This yields a particularly compact design of the hybrid transmission device.

Preferably, the hybrid transmission device can include at least one, in particular precisely one, countershaft. In the case that a single countershaft is utilized, a single point of connection to the differential is present. As a result, installation space can be saved, which is the case in the radial direction as well as in the axial direction.

Preferably, precisely one engagement device can be arranged on the countershaft. In addition, advantageously, precisely two idler gears can be arranged on the countershaft. Advantageously, the engagement device on the countershaft can be designed to be two-sided.

The engagement device arranged on the countershaft can be arranged offset in the axial direction with respect to the or multiple engagement device(s) on one of the transmission input shafts, in particular the first transmission input shaft. Preferably, the engagement device can be arranged on the countershaft in the axial direction closer to the internal combustion engine than the engagement device on the first transmission input shaft. As a result, a particularly compact arrangement of the hybrid transmission device can be achieved.

Preferably, all shift elements of the engagement devices on the countershaft can be designed as gearshift clutches.

Preferably, at least one, in particular precisely one, fixed gear can be located on the countershaft for forming a forward gear step. In addition, a fixed gear can be located on the countershaft for establishing a connection to the differential. However, this is not a fixed gear for forming a forward gear step.

Advantageously, a single fixed gear for forming a forward gear step can be arranged on the countershaft, which is arranged at an axial end of the countershaft. Preferably, a fixed gear is located each of the axial ends of the countershaft and, therebetween, two idler gears.

In addition, the hybrid transmission device can include a control device. This is designed for controlling the transmission as described.

In addition, example aspects of the invention relate to a hybrid drive train including a hybrid transmission device and at least one electric axle, in particular a rear axle. The hybrid drive train is distinguished by the fact that the hybrid transmission device is designed as described. This configuration is preferably arranged with a single drive device in the hybrid transmission device. An electric axle is an axle having an electric motor associated therewith. The output of drive torque by the electric motor of the electric axle therefore first takes place in the power flow behind the hybrid transmission device. Preferably, the electric axle is an assembly unit. The assembly unit can also include a separate transmission for multiplying the drive torque of the electric motor of the electric axle. This is preferably designed as a gear change transmission.

When an electric axle is utilized, the electric axle can support the drive torque.

Example aspects of the invention also relate to a motor vehicle with an internal combustion engine and a hybrid transmission device or a hybrid drive train. The motor vehicle is distinguished by the fact that the hybrid transmission device or the hybrid drive train is designed as described.

Advantageously, the hybrid transmission device is arranged in the motor vehicle as a front-mounted transverse transmission device.

Preferably, the motor vehicle includes a control device for the open-loop control of the hybrid transmission device. The control device can therefore be part of the hybrid transmission device, although the control device does not need to be.

Preferably, a battery is arranged in the motor vehicle, which allows for an electric operation of the motor vehicle for at least fifteen (15) minutes. Alternatively, for a purely electric operation, the internal combustion engine, with one of the electric motors as a generator, can generate current, which goes directly to the other electric motor.

In addition, the motor vehicle can include a pressure reservoir. This can be utilized for operating a fluid power machine.

### BRIEF DESCRIPTION OF THE DRAWINGS

Further advantages, features, and details of the invention result from the following description of exemplary embodiments and figures, in which:

FIG. 1 shows a motor vehicle;

FIG. 2 shows a gear set scheme in a first example embodiment;

FIG. 3 shows a gear set scheme in a second example embodiment; and

FIG. 4 shows a hybrid transmission device in a side view.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

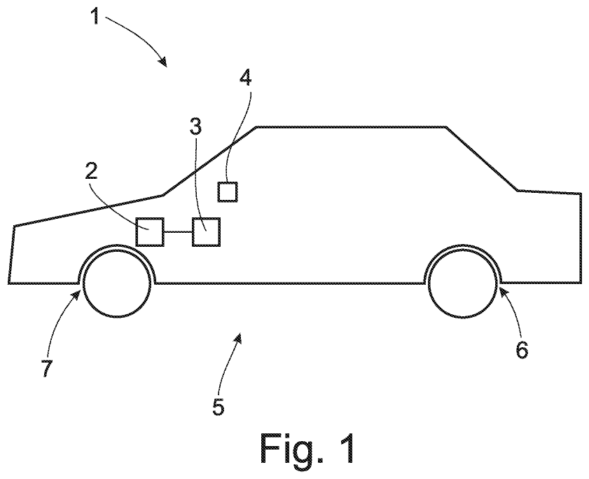

FIG. 1 shows a motor vehicle 1 with an internal combustion engine 2 and a hybrid transmission device 3. The hybrid transmission device 3 also includes, as described in greater detail further below, at least one electric motor and shift elements, and so the hybrid transmission device 3 can be installed as an assembly unit. This is not absolutely necessary, however. In principle, the hybrid transmission device 3 can form an assembly unit even without previously connected electric motors. A control device 4 is provided for the open-loop control of the hybrid transmission device 3. This can be part of the hybrid transmission device 3 or of the motor vehicle 1.

The hybrid drive train 5 can also include, in addition to the internal combustion engine 2 and the hybrid transmission device 3, at least one electric axle 6. The electric axle 6 is preferably the rear axle when the hybrid transmission device 3 is arranged as a front-mounted transverse transmission and drives the front axle 7, and vice versa.

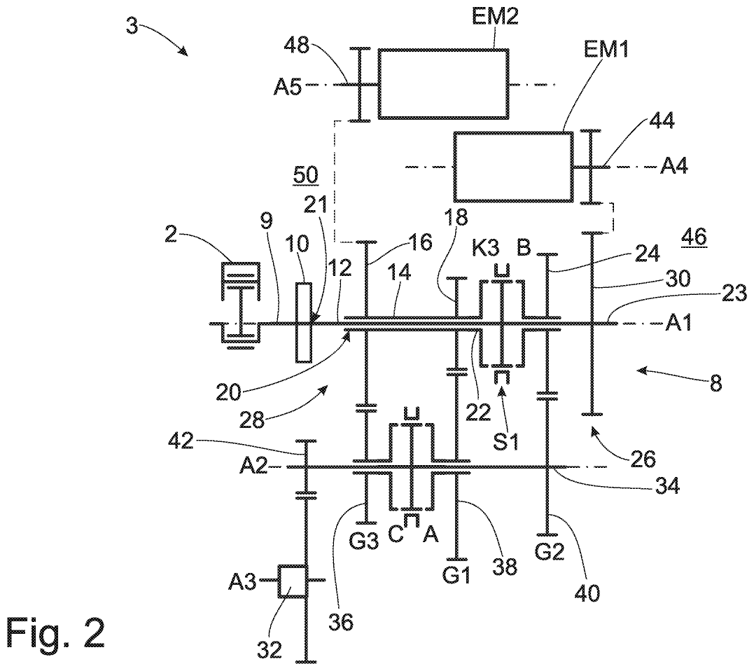

FIG. 2 shows the hybrid transmission device 3 and, in particular, the gear change transmission 8, in the form of a gear set scheme. In the following, the hybrid transmission device 3 will be described starting from the internal combustion engine 2. The crankshaft 9 is connected to the first transmission input shaft 12 via a damper unit 10. The damper unit 10 can include a torsion damper and/or a damper, in particular a rotational speed-adaptive damper, and/or a slipping clutch. A second transmission input shaft 14 is mounted on the first transmission input shaft 12. Two fixed gears 16 and 18 are arranged on the second transmission input shaft 14. The fixed gear 16 is the fixed gear of the third gear step G3 and the fixed gear 18 is the fixed gear of the first gear step G1.

The second transmission input shaft 14 has two ends, namely one end 20 facing the outer side of the hybrid transmission device 3 and one end 22 facing the inner side of the hybrid transmission device 3. The first transmission input shaft 12 has an end 21 facing the engine and an end 23 facing away from the engine, wherein reference is made here to the position in comparison to the internal combustion engine 2.

An engagement device S1 with a clutch K3 and a gearshift clutch B mounted on the first transmission input shaft 12 follows. By the gearshift clutch B, an idler gear 24 can be rotationally fixed to the first transmission input shaft 12. The idler gear 24 is the idler gear of the second gear step G2.

The clutch K3 can connect the sub-transmissions 26 and 28. The sub-transmission 26 has a single even gear step, the gear step G2. The sub-transmission 28 has the odd gear steps G1 and G3.

The connecting gearwheel 30 follows on the first transmission input shaft 12. The task of the connecting gearwheel 30 is to connect the electric motor EM1 to the first transmission input shaft 12 and, thereby, to the transmission 8. The connecting gearwheel 20, therefore, is not a gear-step gearwheel.

The second transmission input shaft 14 is therefore designed to be shift element-free and idler gear-free. A single engagement device S1 is arranged on the first transmission input shaft 12. The engagement device S1 includes the clutch K3 and the gearshift clutch B and, therefore, is designed to be two-sided.

The axis of rotation of the first transmission input shaft 12 and of the second transmission input shaft 14 is labeled with A1.

The hybrid transmission device 3 includes a single countershaft 34 for connection to a differential 32 and to form the gear stages or gear steps. Arranged on the countershaft 34 is a single engagement device S2 with the gearshift clutches A and C for connecting the idler gears 36 and 38 to the countershaft 34. As the sole gear-implementing fixed gear, the fixed gear 40 is located on the countershaft 34. The assignment to the gear steps results on the basis of the gear step numbers G1 through G3 below the gearwheels arranged on the countershaft 34. The fixed gear 42 is not a gear-implementing fixed gear. The fixed gear 42 connects the countershaft 34 to the differential 32 as a drive output constant. On the basis of this scheme, the following can be determined with respect to the gear steps:

One fixed gear and one idler gear are associated with each gear step and, in fact, a single fixed gear and a single idler gear in each case. Each fixed gear and idler gear are always unambiguously associated with a single gear step, i.e., there are no winding-path gears by utilizing one gearwheel for multiple gear steps. Nevertheless, the gear steps G1 and G3 can be considered to be coupling gears, since the first transmission input shaft 12 is interconnected during the formation of the gear steps G1 and G3.

The electric motors EM1 and EM2 are connected as shown and, in fact, at the axially external gearwheels 16 and 30. In particular, due to the connection of the electric motors EM1 and EM2 at the axially outermost gearwheels 16 and 30, an axially extremely short hybrid transmission device 3 can be created.

The electric motors EM1 and EM2 are arranged in parallel to the transmission input shaft 12 and the electric motors EM1 and EM2 have outputs at opposite sides. This means, as shown in FIG. 2, the output and/or the output shaft 44 of the electric motor EM1 points toward the end 46 of the gear change transmission 8 facing away from the motor and the output shaft 48 of the electric motor EM2 points toward the end 50 of the gear change transmission 8 facing the motor. In FIG. 2, one end therefore points toward the left and one end points toward the right. The electric motors EM1 and EM2 are arranged partially overlapping in the axial direction. Due to the above-described arrangement of the shift elements S1 and S2 and the design of the reverse gear without a reversing gearwheel, a length of the hybrid transmission device 3 of slightly more than thirty centimeters (30 cm) is made possible.

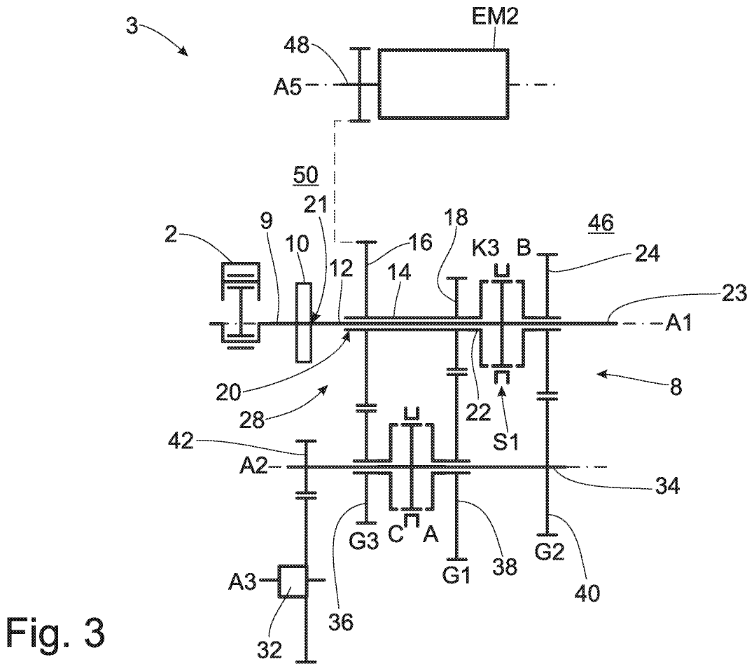

FIG. 3 shows a modification of the configuration according to FIG. 2. The only difference is that the electric motor EM1 in the transmission is dispensed with. An electric power shiftability can then be achieved between the electric motor EM2 in the hybrid transmission device 3 and the electric axle 6.

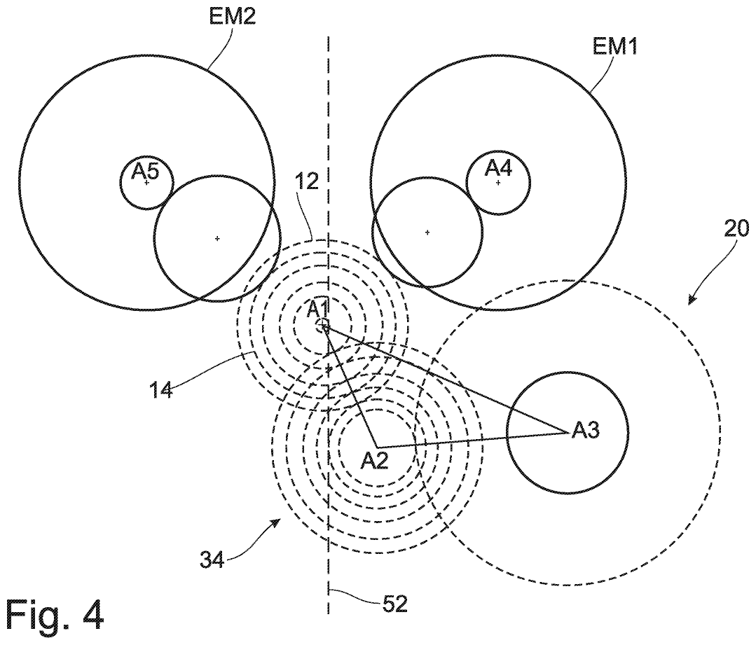

FIG. 4 shows a side view of the transmission according to FIG. 2. The axes A4 and A5 of the electric motors EM1 and EM2 are arranged above and laterally with respect to the axis A1 of the first transmission input shaft 12 and also of the second transmission input shaft 14. The axis A2 of the countershaft 34 and the axis A3 of the differential 32 are advantageously situated below the axis A1 of the first transmission input shaft 12. The axes A4 and A5 are arranged symmetrically with respect to the axis A1 in such a way that the distance of the axes A4 and A5 to the axis A1 is identical and the angle with respect to the perpendicular 52 is also identical.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission device
4 control device
5 hybrid drive train
6 electric axle
7 front axle
8 gear change transmission
9 crankshaft
10 damper unit
12 first transmission input shaft
14 second transmission input shaft
16 fixed gear
18 fixed gear
20 end
21 end
22 end
23 end
24 idler gear
26 sub-transmission
30 sub-transmission
32 differential
34 countershaft
36 idler gear
38 idler gear
40 fixed gear
42 gearwheel
44 output shaft
46 end facing away from the motor
48 output shaft
50 end facing the motor
52 perpendicular
K3 clutch
S1 engagement device
S2 engagement device
A gearshift clutch
B gearshift clutch
C gearshift clutch
EM1 electric motor
EM2 electric motor
A1 axis
A2 axis
A3 axis
A4 axis
A5 axis

1-15: (canceled)

16. A hybrid transmission device (3), comprising:
at least one drive device (EM2);
a transmission (4) with a first transmission input shaft (12) and a second transmission input shaft (14) mounted on the first transmission input shaft (12); and
a differential (32) arranged in an axial direction at an engine-side end (21) of the first transmission input shaft (12).

17. The hybrid transmission device of claim 16, further comprising a connecting clutch (K3) configured for connecting the first transmission input shaft (12) and the second transmission input shaft (14).

18. The hybrid transmission device of claim 16, wherein the first transmission input shaft (12) is connected or connectable without a clutch to a crankshaft (9).

19. The hybrid transmission device of claim 18, wherein the first transmission input shaft (12) is connected or connectable to the crankshaft (9) via a damper unit (10).

20. The hybrid transmission device of claim 16, wherein the second transmission input shaft (14) is exclusively connectable, on an input side, to the first transmission input shaft (12).

21. The hybrid transmission device of claim 16, wherein each of the at least one drive device (EM1, EM2) is associated with one or both of the first transmission input shaft (12) and the second transmission input shaft (14).

22. The hybrid transmission device of claim 16, further comprising precisely two two-sided engagement devices (S1, S2) configured for producing three internal-combustion-engine and/or electric gear steps (V1, V2, V3, E1, E2, E3).

23. The hybrid transmission device of claim 16, wherein:
at least two gear-step gears (16, 18) of the transmission (4) are arranged on the second transmission input shaft (14); and
wherein the one (16) of the at least two gear-step gears (16, 18) corresponding to a highest gear step (G3) of the transmission (4) is arranged on the second transmission input shaft (14) in an axial direction toward an outer side (46, 50) of the second transmission input shaft (14).

24. The hybrid transmission device of claim 23, wherein the at least two gear-step gears (16, 18) form odd gears (G1, G3) of the transmission (4).

25. The hybrid transmission device of claim 16, wherein the at least one drive device comprises a first drive device (EM1) and a second drive device (EM2) that are arranged axially parallel.

26. The hybrid transmission device of claim 16, further comprising at least one countershaft (34).

27. The hybrid transmission device of claim 26, further comprising at least one engagement device (S1, S2) arranged on one or both of the countershaft (34) and the first transmission input shaft (12).

28. The hybrid transmission device of claim 26, further comprising precisely one engagement device (S1, S2) arranged on one of the countershaft (34) and the first transmission input shaft (12).

29. The hybrid transmission device of claim 26, wherein precisely one fixed gear for forming a forward gear step (G2) is arranged on the countershaft (34).

30. The hybrid transmission device of claim 16, further comprising only one countershaft (34).

31. The hybrid transmission device of claim 30, further comprising precisely one engagement device (S1, S2) arranged on one of the countershaft (34) and the first transmission input shaft (12).

32. The hybrid transmission device of claim 30, wherein precisely one fixed gear for forming a forward gear step (G2) is arranged on the countershaft (34).

33. The hybrid transmission device claim 16, wherein the at least one drive device (EM2) is connected to a gear-step fixed gear.

34. The hybrid transmission device, further comprising two sub-transmissions (26, 28), wherein one of the sub-transmissions (26) has a single gear step (G2).

35. A motor vehicle (1), comprising the hybrid transmission device of claim 16.
